(19) United States
(12) Patent Application Publication
(10) Pub. No.: US 2011/0001104 A1
(43) Pub. Date: Jan. 6, 2011

(54) Attachment mechanism and fence system using the same

(75) Inventors: Michael Rowley, Munster, IN (US); David Kurth, Dyer, IN (US)

Correspondence Address: Brinks Hofer Gilson & Lione, PO Box 10395, Chicago, IL, 60610, US

(73) Assignee: ON THE FENCE TECHNOLOGIES LLC, CORPORATION

(21) Appl. No.: 12/807,725

(22) Filed: Sep. 13, 2010

Related U.S. Application Data
(63) Continuation-in-part of application No. 12/799,167, filed on Apr. 19, 2010.
Application No. 12/799,167 is a continuation-in-part of application No. 12/321,842, filed on Jan. 26, 2009.
Application No. 12/321,842 is a continuation of application No. 11/335,098, filed on Jan. 18, 2006, now abandoned.
Application No. 11/335,098 is a continuation-in-part of application No. 11/293,454, filed on Dec. 2, 2005, now Pat. No. 7,389,975.
Application No. 11/293,454 is a continuation-in-part of application No. 10/347,972, filed on Jan. 21, 2003, now Pat. No. 7,032,891.
(60) Provisional application No. 61/276,883, filed on Sep. 17, 2009.
(60) Provisional application No. 61/214,431, filed on Apr. 23, 2009.
(60) Provisional application No. 60/645,218, filed on Jan. 18, 2005.

(51) Int. Cl. E04H 17/20; B23P 19/02

(52) U.S. Cl. 256/65.03; 29/525

(57) ABSTRACT

A fence system including a first post attached in the ground and a second post attached in the ground. The fence system also includes a rail coupled to the first post and the second post with a female member attachment mechanism and a lip. The fence system also includes a slat including a male member attachment mechanism with a flap and a locking mechanism defining a step. The slat is coupled to the rail such that the male member attachment mechanism is coupled to the female member attachment mechanism and the step abuts the lip. If a force is applied to remove the male member attachment mechanism from the female member attachment mechanism, the lip exerts a force on the step resisting the force applied to remove the male member attachment mechanism.

### PRIORITY CLAIM

This application claims the benefit of the filing date of U.S. Provisional Patent Application Ser. No. 61/276,883, filed on Sep. 17, 2009, and this application is a continuation-in-part application of U.S. patent application Ser. No. 12/799,167, filed on Apr. 19, 2010 (pending), which claims the benefit of the filing date of U.S. Provisional Patent Application Ser. No. 61/214,431 filed on Apr. 23, 2009, wherein U.S. patent application Ser. No. 12/799,167 is a continuation-in-part application of U.S. patent application Ser. No. 12/321,842 filed Jan. 26, 2009, which is a continuation of U.S. patent application Ser. No. 11/335,098, filed Jan. 18, 2006, which claims the benefit of the filing date of U.S. Provisional Patent Application Ser. No. 60/645,218, filed Jan. 18, 2005, wherein U.S. patent application Ser. No. 11/335,098 is a continuation-in-part application of both U.S. patent application Ser. No. 11/293,454, filed on Dec. 2, 2005, now U.S. Pat. No. 7,389,975, and U.S. patent application Ser. No. 10/347,972, filed on Jan. 21, 2003, now U.S. Pat. No. 7,032,891, wherein U.S. patent application Ser. No. 11/293,454 is a divisional application of U.S. patent application Ser. No. 10/347,972, and wherein each of the above mentioned U.S. regular and provisional applications is incorporated in its entirety by reference herein

### BACKGROUND OF THE INVENTION

1. Field of the Invention

This invention relates to improvements in fencing systems and other outdoor structures, and more particularly relates to an improved apparatus and methods of construction and use that allows the structure to be constructed and deconstructed with limited additional resources and relative ease. The invention is particularly suitable for use with fencing systems and other outdoor structures constructed from plastic materials such as vinyl or PVC.

2. Discussion of Related Art

Fencing is commonly used in public and private locations to provide security by barring entry to the enclosed locations to provide privacy, or to improve the aesthetic appearance of the area. Most fencing has a fixed structural design and is built from a number of pieces of hardware. Many fences are built to remain permanently in essentially the same place and condition of appearance. Building a fence may require the use of nails, screws, bolts, clasps, and other external clips to hold portions of the fence together, and the process may be long and laborious. Many fences require the use of tools or heavy equipment to connect portions of the fence with itself. Expensive maintenance is often required to preserve the original condition and appearance of the fence. Any substantial change in the use or appearance of the fence usually requires strenuous activity such as reconstruction or painting. These prior fence constructions are not changeable or adjustable to provide the fence with a new or different use or appearance.

Some of these same disadvantages also arise with other outdoor structures, such as a railing or a deck that may be constructed of wood or similar products through the use of nails, bolts, screws, hammers, screwdrivers, and power tools. It is difficult and expensive to build such structures, and it is hard to change the function or appearance of an outdoor rail or deck component once it is installed in place. Substantial costs would also be involved in attempting to manufacture and inventory the different components needed to selectively change the function or appearance of the structure.

### BRIEF SUMMARY OF THE INVENTION

One aspect of the present invention regards a fence system including a first post attached in the ground and a second post attached in the ground. The fence system also includes a rail coupled to the first post and the second post with a female member attachment mechanism and a lip. The fence system also includes a slat including a male member attachment mechanism with a flap and a locking mechanism defining a step. The slat is coupled to the rail such that the male member attachment mechanism is coupled to the female member attachment mechanism and the step abuts the lip. If a force is applied to remove the male member attachment mechanism from the female member attachment mechanism, the lip exerts a force on the step resisting the force applied to remove the male member attachment mechanism.

A second aspect of the present invention regards a fence system including a first post attached in the ground and a second post attached in the ground. The fence system also includes a rail including a male member attachment mechanism with a flap and a locking mechanism defining a step, where the rail is coupled to the first post and the second post. The fence system also includes a slat with a female member attachment mechanism and a lip. The rail is coupled to the slat such that the male member attachment mechanism is coupled to the female member attachment mechanism and the step abuts the lip. If a force is applied to remove the male member attachment mechanism from the female member attachment mechanism, the lip exerts a force on the step resisting the force applied to remove the male member attachment mechanism.

A third aspect of the present invention regards a slat including a male member attachment mechanism. The male member attachment mechanism includes a flap with a first end coupled to the slat and a second end defining an interior boundary of an opening. The second end is rounded and protrudes from the slat. The male member attachment mechanism also includes a locking mechanism in communication with the flap. A side of the locking mechanism protrudes from the flap and defines a step. The step is at the first end of the flap between the side of the locking mechanism and the slat. The slat defines the outer boundary of the opening.

A fourth aspect of the present invention regards a kit including a slat and a rail. The slat includes a male member attachment mechanism with a flap and a locking mechanism. The flap includes a first end coupled to the slat and a second end defining an interior boundary of an opening. The second end is rounded and protrudes from the slat. The locking mechanism in communication with the flap. A side of the locking mechanism protrudes from the flap and defines a step. The step is at the first end of the flap between the side of the locking mechanism and the slat. The slat defines the outer boundary of the opening. The rail includes a female member attachment mechanism with a protruding portion of the rail and defining a portion a gap in the rail. The rail defines the rest of the gap in the rail. The gap is configured to receive the male member attachment mechanism. The fail also includes a lip configured to engage the step when the gap receives the male member attachment mechanism.

A fifth aspect of the present invention regards a method of attaching two rails together. The method includes placing a first rail including a male member attachment mechanism including a flap and a locking mechanism defining a step adjacent to a second rail including a female member attachment mechanism and a lip. The method also includes applying a force such that the flap of the male member attachment mechanism enters the female member attachment mechanism until the step abuts the lip. Once the step abuts the lip, if a force is applied to remove the male member attachment mechanism from the female member attachment mechanism, the lip exerts a force on the step resisting the force applied to remove the male member attachment mechanism.

### BRIEF DESCRIPTION OF THE DRAWINGS

FIG. 1 shows a front view of an embodiment of a fence system in accordance with the present invention.

FIGS. 2A-C include a front view (FIG. 2A) of a portion of a fence slat including a male member attachment mechanism, a cutout top view (FIG. 2B) of the fence slat with the male member attachment mechanism, and a side view (FIG. 2C) of a portion of a fence slat with the male member attachment mechanism for use with the fence system of FIG. 1 in accordance with the present invention.

FIGS. 3A-C include a front view (FIG. 3A) of a portion of a fence rail including a female member attachment mechanism, a cutout side view (FIG. 3B) of the fence rail with the female member attachment mechanism, and a top view (FIG. 3C) of a portion of a fence rail with the female member attachment mechanism for use with the fence system of FIG. 1 in accordance with the present invention.

FIG. 4 shows an elevated front view of a portion of fence picket of FIGS. 2A-C including a male member attachment mechanism for use with the fence system of FIG. 1 in accordance with the present invention.

FIGS. 5A-B show two side views of alternative embodiments of a male member attachment mechanism for use with the fence system of FIG. 1 and fence slat of FIGS. 2A-C in accordance with the present invention.

FIG. 6 shows an enlarged side cutout view of the fence rail of FIGS. 3A-C with a female member attachment mechanism for use with the fence system of FIG. 1 in accordance with the present invention.

FIGS. 7A-B include a front view (FIG. 7A) and a side view (FIG. 7B) of the fence slat of FIGS. 2A-C and the fence rail of FIGS. 3A-C attached together through the use of a male member attachment mechanism coupled with a female member attachment mechanism in accordance with the present invention.

FIG. 8 shows a cutout side view along the line C-C shown in FIGS. 7A-B of the fence slat of FIGS. 2A-C and the fence rail of FIGS. 3A-C attached together through the use of a male member attachment mechanism coupled with a female member attachment mechanism as shown in FIG. 7.

### DETAILED DESCRIPTION OF THE DRAWINGS AND THE PRESENTLY PREFERRED EMBODIMENTS

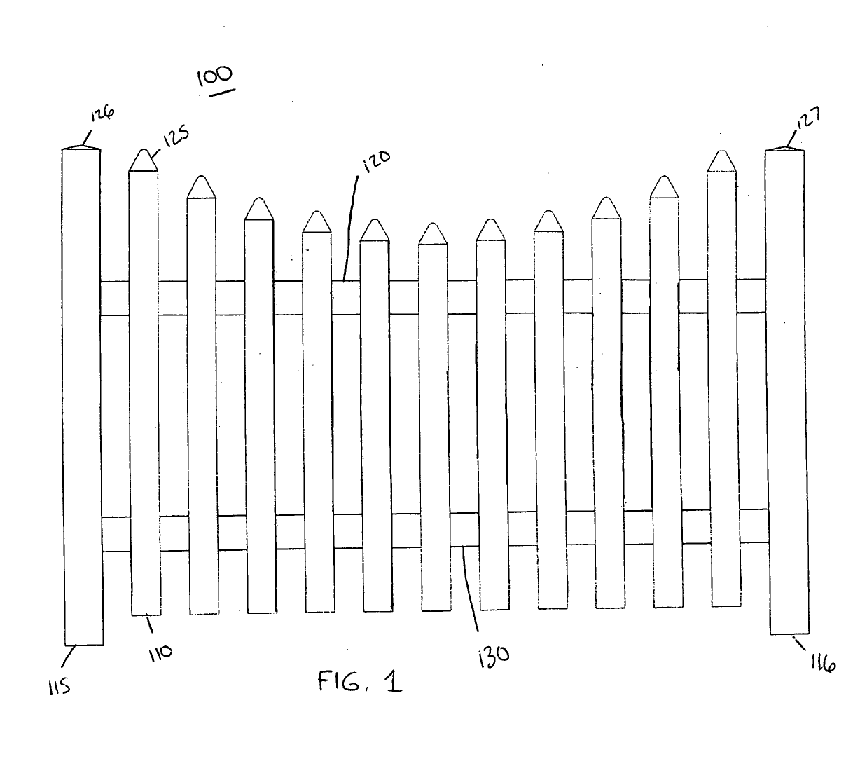

FIG. 1 illustrates a front view of a portion of a fence system in accordance with the present invention. The fence system 100 includes vertical side fence posts 115 and 116, top horizontal fence rail 120, and bottom horizontal fence rail 130. The fence system 100 includes a series of vertical pickets or fence slats 110 positioned substantially parallel to each other and coupled to the horizontal fence rails 120 and 130. End caps 125-27 may be placed over one or both ends of the fence posts 115 and 116, the fence slats 110, and the fence rails 120 and 130. These fence posts 115 and 116, fence slats 110, and fence rails 120 and 130 can be selectively and readily adjusted to change the use, function, or appearance of the fence system 100. As shown in FIG. 1, multiple sizes of fence slats 110 may be used in the same fence system 100. Fence slats 110 and fence rails 120 and 130 of any size or dimension may be used.

The portion of the fence system 100 having the posts 115 and 116, fence slats 110, and fence rails 120 and 130, as shown in the fence system 100 illustrated in FIG. 1, may incorporate one or more of the embodiments of the fences as described in U.S. patent application Ser. No. 12/321,842, U.S. patent application Ser. No. 11/335,098, which is a continuation-in-part application from U.S. patent application Ser. No. 10/347,972, now U.S. Pat. No. 7,032,891, U.S. patent application Ser. No. 12/321,842, and U.S. patent application Ser. No. 12/799,167, which claims the benefit of the filing date of U.S. Provisional Patent Application Ser. No. 61/214,431.

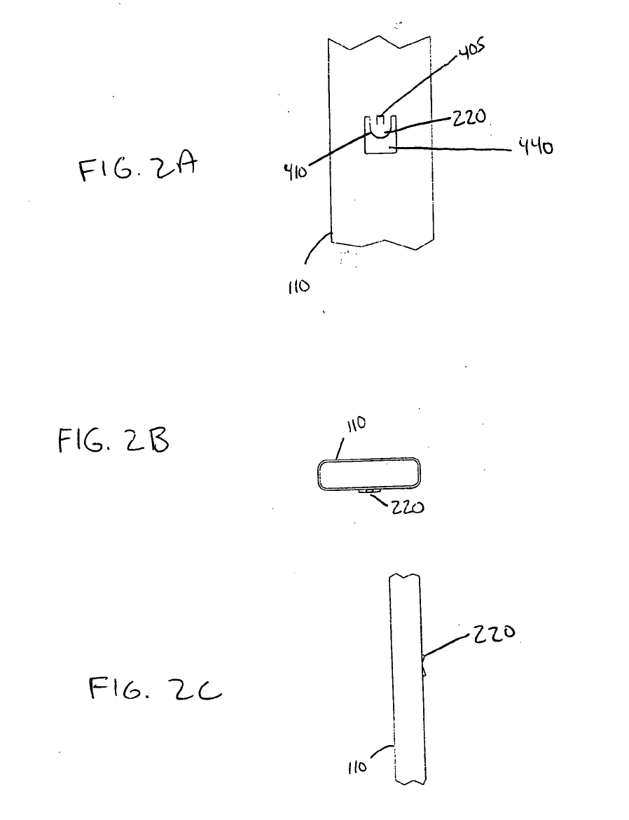

Fence posts 115 and 116 may be mounted into the ground. Horizontal fence rails 120 and 130 may be coupled to the fence posts 115 and 116 in any number of ways, including any manner described in the above applications incorporated by reference. The rails 120 and 130 may be attached to posts 115 and 116 via the attachment mechanism disclosed hereinafter with respect to FIGS. 2-8. The vertical slats 110 may be connected to the horizontal fence rails through the use of the attachment mechanism disclosed hereinafter with respect to FIGS. 2-8. Preferably, the fence may be in an outdoor setting and exposed to the elements.

The fence system 100 in FIG. 1 may be designed as a series of fence slats 110 and fence posts 115 and 116 arranged substantially parallel to each other and coupled to two horizontal fence rails 120 and 130 arranged perpendicular to the fence slats 110. Alternatively or additionally, fence posts 115 and 116 and fence slats 110 and fence rails 120 and 130 may be placed at any angle with each other, including, for example, diagonally, horizontally, or parallel. Different shapes and sizes of fence posts 115 and 116, fence slats 110, or fence rails 120 or 130 can be used to construct a variety of other framework patterns for the fence system 100. The frameworks may incorporate a Highland fence pattern, or a Window Pane fence pattern. Alternatively, or additionally, the frameworks may include any combination of horizontal, vertical, or diagonal bars, spaced and arranged to form a decorative structure. Alternatively, or additionally, the frameworks may include an ornamental and/or structural criss-cross or arrangement of crossing laths or other thin strips of material. Alternatively, or additionally, the frameworks may include crossed strips arranged to form a regular or irregular pattern of open spaces, or a geometrical arrangement of positional lines over an area or space. Alternatively, or additionally, the fence system 100 may incorporate any other pattern which includes openings, gaps, spaces, holes, or other straight-edged or curved voids, for decorative or functional purposes.

The posts, rails, slats, and other components of the fence system 100 may be made in part or in whole of plastic, vinyl, or PVC. Alternatively, the components may be made from metal, plastic, fiberglass, glass, wood, or any other material which may serve as a suitable framework for decorative or functional purposes. Any combination of materials is possible. In the preferred embodiments these components of the fence system 100 are hollow and can be constructed from plastic materials such as polyvinyl chloride (PVC). The components of the fence system 100 can be injection or blow molded, or extruded, and the like.

Part or all of the components may be placed between two or more shaped die tools which may squeeze, causing a change in the shape of the component. This change in shape may be permanent. The change in shape may be semi-permanent. The change in shape may be such that if an external force is applied to the component, the component may temporarily deform or bend as a result of the force, but when the force is released, the component may return to the shape created by the die tools. As a result of the change in the component, the component may possess a spring-like quality, such that the component may be temporarily deformed or bent through an applied force, but will spring back into a resting position when the force is no longer applied.

Some or all of the components may be made of different materials than other components. The components of the fence system 100 may be any color or combination of colors, any transparency, and have any texture or combination of textures.

As shown by FIGS. 2A-C and 4, the male member attachment mechanism 220 may be constructed as a part of the fence slat 110. For example, the fence slat 110 may be formed such that the male member attachment mechanism 220 is inherently a part of the fence slat 110, such as through injection, blow molding, or shaping by die tools. Alternatively or additionally, the male member attachment mechanism 220 may be added to the fence slat 110 after the fence slat 110 was created.

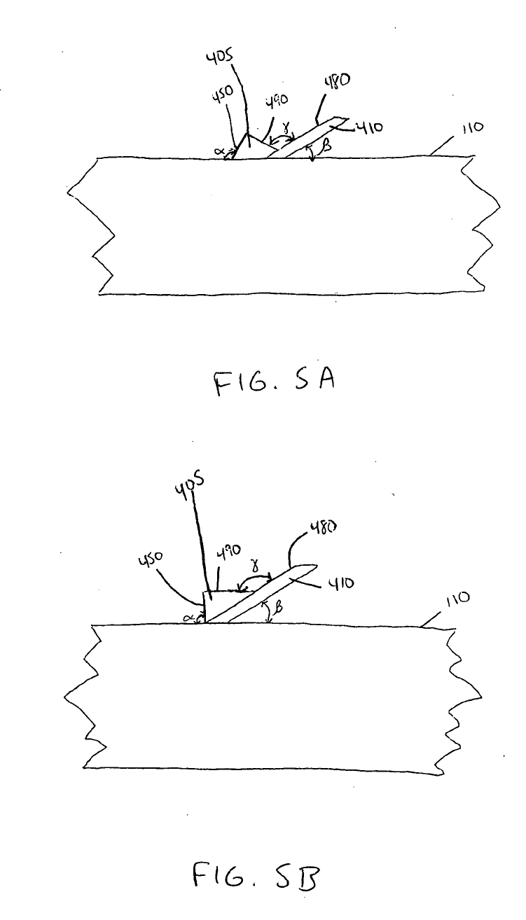

The male member attachment mechanism 220 may include a locking element 405 and a flap 410. The flap 410 may extend outward from the fence slat 110. Additionally or alternatively, the flap 410 may bend outward at a certain angle from the fence slat 110. This bend may be along the axis shown by bend mark 420, generally shown in FIG. 5A. Alternatively, the flap 410 may bend along the axis shown by bend mark 430, as shown in FIG. 5B. In this latter embodiment, the top surface of the locking element 405 may be parallel to the face of the fence slat 110.

The flap 410 may extend or bend outward from the fence slat 110 at any number of points or along any number of lines on the male member attachment mechanism 220. The flap 410 may extend or bend outward from the fence slat 110 any amount or at any angle β. In a preferred embodiment, the flap 110 bends along bend mark 430 where β is between 10 and 45 degrees. Though FIG. 5 shows the flap 410 as extending straight out along a bend mark, the flap may alternatively curve away from the fence slat 110. Any bend or curve of the flap 410 may result from the creation of the fence slat 110 or through the application of a shaped die tool.

An opening 440 may exist between a portion of the flap 410 and the rest of the fence slat 110. As shown in FIGS. 2A-C, the flap 410 may be U-shaped. The flap 410 may be any shape, including rectangular, semi-circular, or any other regular or irregular shape. This opening may be any size. The opening may be U-shaped, with a generally rectangular outer border and a rounded U-Shaped inner border defined by the edge of the flap 410. In a preferred embodiment, the opening is configured so that the female member attachment mechanism 330 may be coupled to the male member attachment mechanism 220. The opening 440 may be configured such that the edges of the female member attachment mechanism 330 may be received in the sides of the opening 440.

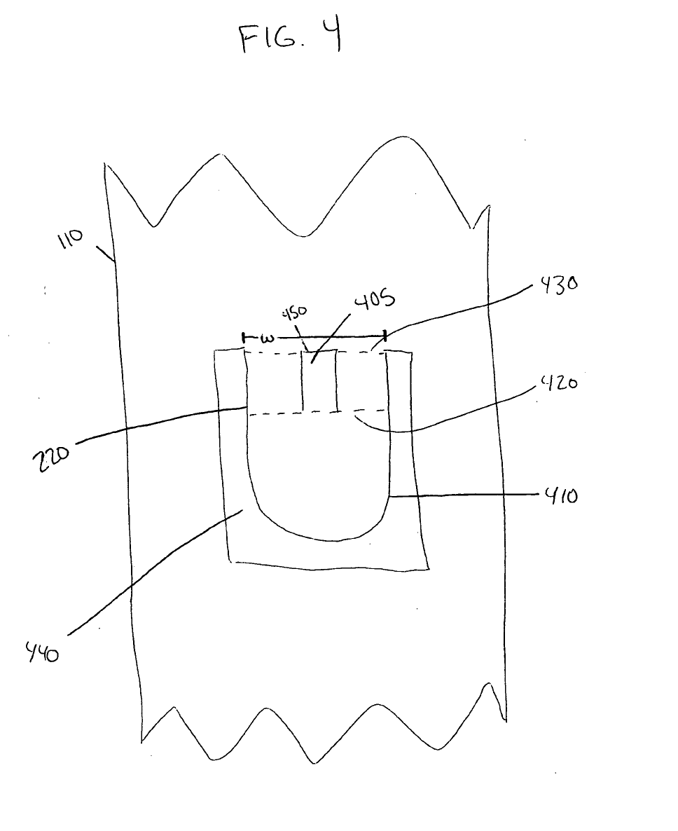

The male member attachment mechanism 220 also may include a locking element 405. Locking element 405 may extend along only a portion of the width of the base of the male member attachment mechanism 220 which connects the flap 410 to the fence slat 110, as shown in FIG. 4. In these embodiments, the locking element 405 may extend along any portion of the width of the male member attachment mechanism 220. Alternatively, the locking element may extend along the entire width “w” of the male member attachment mechanism 220. Any number of locking mechanisms 405 may be used with the male member attachment mechanism 220. For example, in an embodiment, two locking mechanisms 405 are used along the base of one male member attachment mechanism 220, with a space in between.

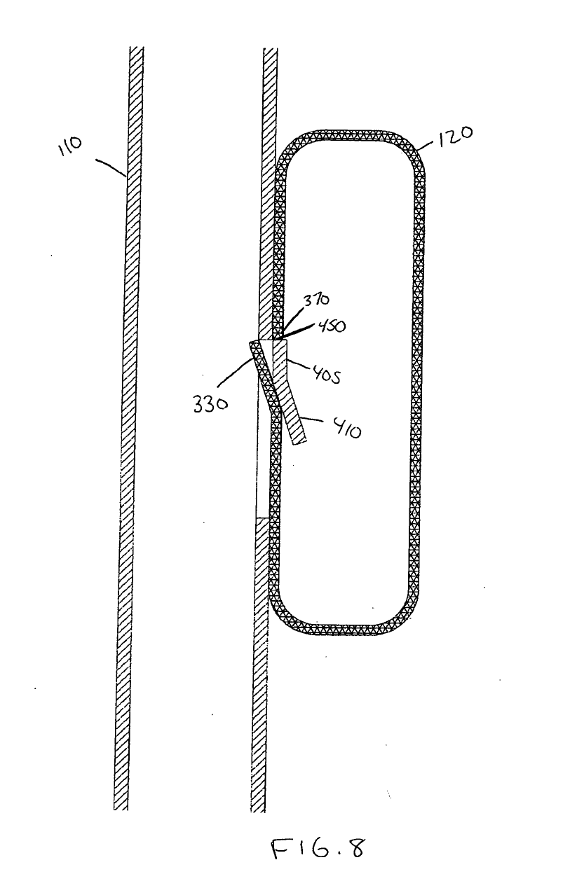

Locking element 405 may be constructed or configured as part of the fence slat 110, or may be added or created separately. In some embodiments, the locking mechanism 405 may appear as a raised tab near the base of the male member attachment mechanism 220. The locking mechanism 405 may be configured or constructed as an indent or punched out portion of the flap 410, as shown in the cutout view of FIG. 8. The locking mechanism 405 may define a step 450 between the base of the male member attachment mechanism 220 and the fence slat 110. Step 450 may appear as a step, tab, hook or cliff. The locking mechanism 405 may be punched out from the flap through the use of die tools, or may not actually be punched out, but may instead be formed to appear as though it was punched out. This may be accomplished through the use of injection or blow-molding used to construct the fence slat 110.

As shown in FIGS. 5A-B, the locking mechanism 405 may include additional materials. For example, the locking mechanism 405 may be a wedge mounted on top of the flap 410, such that the width of the flap 410 increases as one moves from a tip of the flap 410 towards the base of the male member attachment mechanism 220.

The locking element 405 may be configured so as to have a top surface 490 which intersects with the top surface 480 of the flap 410. This intersection may generally be smoother and result in the formation of an angle γ between the surfaces which is nearly flat. In a preferred embodiment, the angle γ formed between these surfaces is between 135 and 180 degrees. The intersection may be described as the intersection of two planes, or it may be a gradual curve.

Locking element 405 may be configured so as to define the step 450 where the locking element 405 is adjacent to or in communication with the fence slat 110. Step 450 may create or appear to create a junction between the fence slat 110 and the locking mechanism 405 at any angle α. In a preferred embodiment, this angle α is between 45 and 135 degrees, as shown in FIGS. 5A-B.

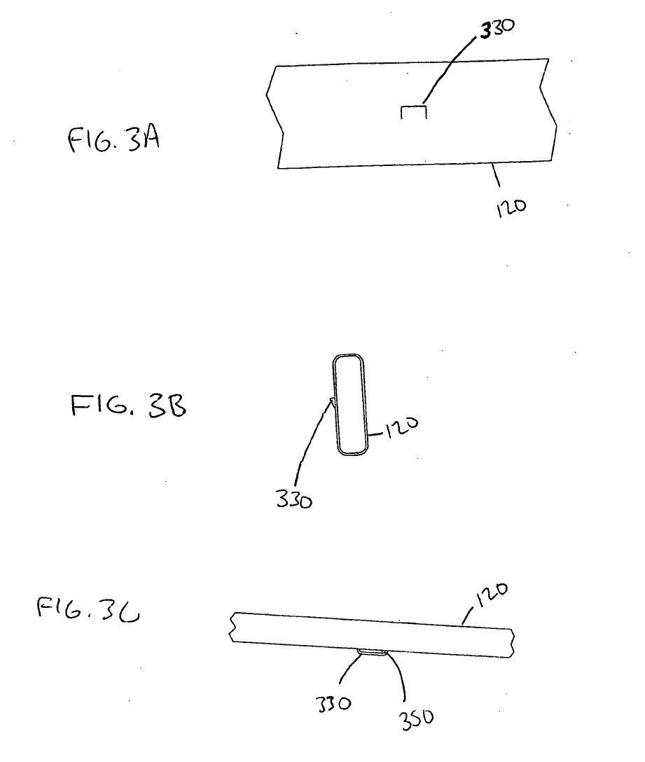

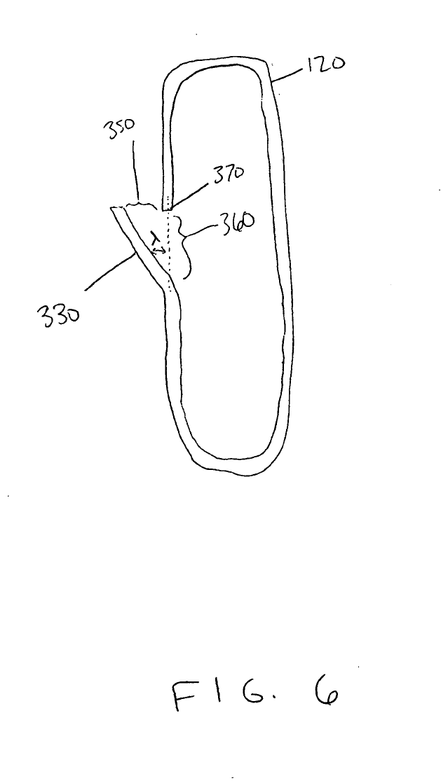

Female member attachment mechanism 330 may be constructed or configured as part of the horizontal fence rail 120 in any manner. As shown by the side view in FIG. 3B, the female member attachment mechanism 330 may extend outward from the horizontal fence rail 120, and a gap 350 may exist between the top of the female member attachment mechanism 330 and the horizontal fence rail 120, as shown in FIG. 3C and in FIG. 6.

The female member attachment mechanism 330 may extend away from the horizontal fence rail at a constant angle λ in a manner similar to how the flap 410 extends away from the fence slat 110. The female member attachment mechanism 330 may be a punched out portion of the horizontal fence rail 120, such that the female member attachment mechanism 330 is a hood. Female member attachment mechanism 330 may be formed as part of the horizontal fence rail when the horizontal fence rail 129 is created. Female member attachment mechanism 330 may be formed in any manner. Additionally or alternatively, the female member attachment mechanism 330 may be constructed or configured from materials external to the horizontal fence rail 120.

The male member attachment mechanism 220 is shown in FIGS. 2A-C as being in the middle of the width of the fence slat 110, while the female member attachment mechanism 330 is configured as being in the middle of the height of the horizontal fence rail 220, as shown in FIGS. 3A-C. However, the attachment mechanisms may be placed along any side or anywhere along any fence rail. Additionally, the male member attachment mechanism 220 is shown as having an axis of symmetry in the same direction as the long portion of the fence slat 110, while the female member attachment mechanism 330 is shown as having an axis of symmetry perpendicular to the long portion of the horizontal fence rail. However, the attachment mechanisms 220 and 330 may be rotated to have an axis of symmetry along any angle. For example, an attachment mechanism may have an axis of symmetry at a 45 degree angle from the fence rail, such that it may be interconnected at any angle.

FIG. 6 illustrates a cutout side view of horizontal fence rail 120 and female member attachment mechanism 330. As shown in FIG. 6, at the top of the female member attachment mechanism 330, a gap 350 exists between the female member attachment mechanism 330 and the horizontal fence rail 120. Additionally, the horizontal fence rail 120 may include a gap 360 which exists along the horizontal fence rail 120. This gap 360 may be constructed or configured such that, when viewed from the front, the female member attachment mechanism 330 acts as a hood over the gap 360. Gap 360 may result when the female member attachment mechanism is punched out from the horizontal fence rail 120, or may be formed when the female member attachment mechanism 330 is created. The gap 360 may be configured such that a lip 370 exists. Lip 370 may define one edge of gap 360. The point or line where the female member attachment mechanism 330 extends away from the horizontal fence rail 120 may define the other edge of the gap 360. Gaps 350 and 360 may be any size or shape hole, opening, or void in which flap 410 may fit snugly.

Female member attachment mechanism 330 may be configured so that the flap 410 of the male member attachment mechanism 220 may slide inside of gap 350 between the female member attachment mechanism 330 and the horizontal fence rail 120. The horizontal fence rail 120 may be configured or constructed so that if the flap 410 of the male member attachment mechanism 220 is slid inside of gap 350, the flap 410 may also slide part of all of the way into gap 360. In this way, the fence slat 110 and the horizontal fence rail 120 may be coupled together.

The coupling of the fence slat 110 and the horizontal fence rail 120 is accomplished by positioning the male member attachment mechanism 220 inside of both gaps 350 and 360, with the locking mechanism 405 inserted beyond the lip 370. Preferably, the male member attachment mechanism 220 fits snugly within the gaps 350 and 360.

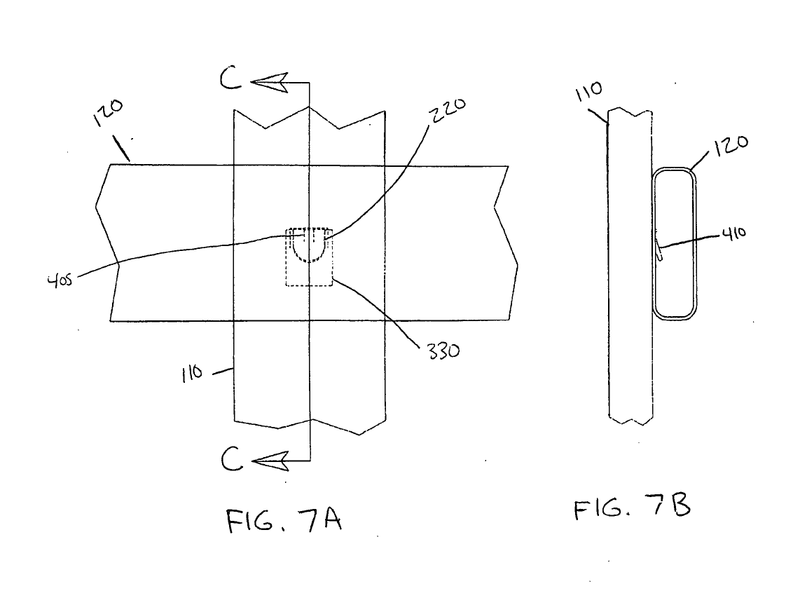

The opening 440 on the fence slat 110 may be large enough so that the edges of the female member attachment mechanism 330 may pass through the opening 440 and into the interior of the fence slat 110. The gaps 350 and 360 on the horizontal fence rail 120 may be configured so that the male member attachment mechanism 220 may fit inside of them. In preferred embodiments, the opening 440 and gaps 350 and 360 are large enough that the male member attachment mechanism can slide into the horizontal fence rail 120 until the planar surfaces of the horizontal fence rail 120 and the fence slat 110 are parallel and touching. This is shown FIG. 7B, which illustrates a side view of the combination shown in FIG. 7A.

It also may be desirable to create the opening 440 and gaps 350 and 360 small enough that, when the male member attachment mechanism 220 and the female member attachment mechanism 330 are slid next to each other, the male member attachment mechanism 220 cannot slide into the gaps 350 and 360 without having a force applied. The locking mechanism 405 may be deformed by the force used to push the male member attachment mechanism 220 through the gap 350. In the preferred embodiment, the male member attachment mechanism 220 needs a force applied to it until the step 450 of the locking mechanism 405 moves past the lip 370, at which point the locking mechanism 405 springs back to its original form, and the step 450 engages the lip, locking the fence slat 110 and fence rail 120 into place, such that the male member attachment mechanism 220 and the female member attachment mechanism 330 fit snugly together as shown in FIG. 8. In some embodiments, when the locking mechanism springs to its original position and engages the lip 370, a user may hear a snapping sound.

FIG. 8 further illustrates how the locking mechanism 405 may work. The gap 350 may be constructed so as to not be wide enough such that the locking mechanism 405 of the male member attachment mechanism 220 passes through the gap 350 without the application of a force. The male member attachment mechanism 220 may be slid into the gap 350 until the top surface of the locking mechanism 405 abuts the lip 370. A force may be applied to either the fence rail 120 or the fence slat 110. Referring to FIG. 8, a force may be applied to the fence rail 120 in the upward direction. Additionally or alternatively, a force may be applied to the fence slat 110 in the downward direction.

The force applied may cause the male member attachment mechanism 220 to push on both the lip 370 and the female member attachment mechanism 330, opening gap 350 wider that it would open at rest. In an embodiment where the locking mechanism 405 is a punched portion of the flap 410, the locking mechanism 405 may be configured to bend inwards toward the flap 410 when a force is applied to the top of locking mechanism 405. In this way, when the force is applied on the fence slat 110 or the fence rail 120 to insert the male member attachment mechanism 220 into gap 350, the locking mechanism 405 may temporarily deform due to the pressure between the lip 370, the female member attachment mechanism 330, and the locking mechanism 405, such that the punched out portion of the flap 410 is also pushed in towards flap 410.

The lip 370 and the female member attachment mechanism 330 may apply resistive forces to keep their normal shape, as may the locking mechanism 405. It is not necessary that all of the lip 370, the female member attachment mechanism 330, and the locking mechanism 405 deform, though any and all may to assist in moving the male member attachment mechanism 220 through gap 350. Because, as illustrated in FIG. 8, the male member attachment mechanism 220 looks similar to a ramp and increases as you move further down the flap 410, a greater force may need to be applied until the step 450 of the locking mechanism 405 passes over the lip 370. At this point, the female member attachment mechanism 330 may retract towards its resting position and push the male member attachment mechanism 220 towards the inside of the horizontal fencing rail 120. Additionally or alternatively, the locking mechanism 405 springs or snaps back to its original punched out position. Once this happens, the step 450 engages the lip 370. Because the male member attachment mechanism 220 is far enough into the gaps 350 and 360 that the step 450 protrudes beyond the lip 370, the lip 370 and the female member attachment mechanism 330 are able to hold the male member attachment mechanism 220 in place. Once the male member attachment mechanism 220 has been inserted in this manner and the punched out portion of the flap 410 (locking mechanism 405) has partially or completely returned to its resting position, if a force is applied to remove the male member attachment mechanism 220 from the gap 350, the step 450 at the base of the male member attachment mechanism 220 hits the edge of the lip 370 and partially or fully resists the force. The male member attachment mechanism 220 cannot easily slide out of the gaps 350 or 360 because the step 450 of the locking mechanism 405 rests against and is engaged with the lip 370. In this way, the locking mechanism 405 acts to ensure that the fence slat 110 and the horizontal fence rail 120 are held in place and not easily detachable without applying a force.

In any embodiment, the locking mechanism 405 may be configured so that when the flap 410 is inserted in a gap 350 to the point where the step 450 of the male member attachment mechanism 220 is beyond the edge of the lip 370, the step 450 of the male member attachment mechanism 220 abuts the lip 370, such that if a force is applied to remove the male member attachment mechanism 220 from the gap 350, the step 450 at the base of the male member attachment mechanism 220 formed by the locking mechanism 405 hits the edge of the lip 370 and partially or fully resists the force.

Though the present disclosure teaches a system where a male member attachment mechanism 220 is configured with the fence slat 110 and the female member attachment mechanism 330 configured with the horizontal fence rail 120, the situation may be reversed, such that the female member attachment mechanism 330 may be configured or constructed with the fence slat 110 and the male member attachment mechanism 220 may be configured or constructed with the horizontal fence rail 120. Attachment of the fence slats 110 and fence rails 120 would be accomplished in a manner similar to that described for FIGS. 1-8.

Any number of fence slats 110 may be used with fence system 100 of FIG. 1, each of which may be configured or constructed with one or more male member attachment mechanisms 220 or female member attachment mechanisms 230. Any number horizontal fence rails 120 may be used, each of which may be configured or constructed with one or more male member attachment mechanisms 220 or female member attachment mechanisms 230. In the embodiment shown in FIG. 1, eleven fence slats 110 are used, each with two male member attachment mechanisms 220 which are configured to be slid and locked into female member attachment mechanisms 230 located on both the top horizontal fence rail 120 and the bottom horizontal fence rail 130. Any number of these attachment mechanisms may be used in conjunction with each other. More than one attachment mechanism may be used to connect two fence slats 110 or fence rails 120. Additionally or alternatively, a fence slat 110 or a horizontal fence rail 120 may include one or more of each of the male member attachment mechanisms 220 and female member attachment mechanisms 330. In one embodiment, the horizontal fence rail 120 includes five male member attachment mechanisms 220 and six female member attachment mechanisms 330, each of which connects to a fence slat 110. In this embodiment, five of the fence slats 110 have female member attachment mechanisms 330 to connect with the five male member attachment mechanisms 220 of the horizontal fence rail 120, and six of the fence slats 110 have male member attachment mechanisms 220 to connect with the six female member attachment mechanisms of the horizontal fence rail 120. Any combination of slats and rails is possible.

Alternatively or additionally, the male member attachment mechanism 220 and female member attachment mechanism 330 may be utilized by other rails or panels, and may be configured on any side or top of such a rail or panel to form any other connection. For example, the attachment mechanisms may be used to connect imitation lumber and form a deck or railing system, with attachment mechanisms located on the side of the rails to interconnect parallel rails. The present invention may be used with outdoor rail or deck components, as well as any fence, wall, or barrier which incorporates any number of attachment mechanisms which are intended to be interconnected.

The attachment mechanisms 220 and 330 are configured to allow the vertical slats and horizontal rails to pivot when connected together, while remaining locked together. This allows the assembled fence or product to conform to uneven landscapes or conditions when installed, while still remaining solidly interconnected. In one embodiment, the opening 440 is configured to be slightly bigger than the width of the female member attachment mechanism 330, such that the female member attachment mechanism 330 may shift or tilt slightly in one or more directions. With a slightly bigger opening 440, the gap 350 may remain the same size, such that, when the male member attachment mechanism 220 is inserted to the point where the locking mechanism 405 is beyond the lip 370, the male member attachment mechanism 220 and the female member attachment mechanism 330 are in the locked position. Further, the design can be used in a vertical, horizontal, or any angled position.

The present invention offers a number of benefits. The fence system 100 may be built without the use of any equipment beyond the rails and posts themselves. No external equipment, such as hammers or power-tools, is required to build the fence. In addition, the present invention allows for quick and easy replacement of portions of a fencing system without requiring the entire fence system to be reconstructed or painted. This reduces costs and increases product versatility. The present invention allows for abundant and interchangeable color and texture choices for fencing. The present invention eliminates fasteners and adhesives.

While the invention has been described above by reference to various embodiments, it will be understood that many changes and modifications can be made without departing from the scope of the invention. It is therefore intended that the foregoing detailed description be regarded as illustrative rather than limiting, and, that it be understood that it is the following claims, including all equivalents, that are intended to define the spirit and scope of this invention.

We claim:

1. A fence system comprising:
a first post attached in said ground;
a second post attached in said ground;
a rail comprising a female member attachment mechanism and a lip, said rail coupled to said first post and said second post;
a slat comprising a male member attachment mechanism comprising a flap and a locking mechanism defining a step;
wherein said slat is coupled to said rail such that said male member attachment mechanism is coupled to said female member attachment mechanism and said step abuts said lip; and
wherein if a force is applied to remove said male member attachment mechanism from said female member attachment mechanism, said lip exerts a force on said step resisting said force applied to remove said male member attachment mechanism.

2. A fence system comprising:
a first post attached in said ground;
a second post attached in said ground;
a rail comprising a male member attachment mechanism comprising a flap and a locking mechanism defining a step, said rail coupled to said first post and said second post;
a slat comprising a female member attachment mechanism and a lip;
wherein said rail is coupled to said slat such that said male member attachment mechanism is coupled to said female member attachment mechanism and said step abuts said lip; and
wherein if a force is applied to remove said male member attachment mechanism from said female member attachment mechanism, said lip exerts a force on said step resisting said force applied to remove said male member attachment mechanism.

3. A slat comprising:
a male member attachment mechanism, comprising:
a flap comprising:
a first end coupled to said slat;
a second end defining an interior boundary of an opening;
wherein said second end is rounded and protrudes from said slat;
a locking mechanism in communication with said flap;
wherein a side of said locking mechanism protrudes from said flap and defines a step;
wherein said step is at said first end of said flap between said side of said locking mechanism and said slat;
wherein said slat defines said outer boundary of said opening.

4. A kit comprising:
a slat comprising:
a male member attachment mechanism, comprising:
a flap comprising:
a first end coupled to said slat;
a second end defining an interior boundary of an opening;
wherein said second end is rounded and protrudes from said slat;
a locking mechanism in communication with said flap;
wherein a side of said locking mechanism protrudes from said flap and defines a step;
wherein said step is at said first end of said flap between said side of said locking mechanism and said slat;
wherein said slat defines said outer boundary of said opening; and
a rail comprising:
a female member attachment mechanism comprising a protruding portion of said rail and defining a portion a gap in said rail;
wherein said rail defines the rest of said gap in said rail;
wherein said gap is configured to receive said male member attachment mechanism;
a lip configured to engage said step when said gap receives said male member attachment mechanism.

5. A method of attaching two rails together comprising:
placing a rail comprising a male member attachment mechanism comprising a flap and a locking mechanism defining a step adjacent to a second rail comprising a female member attachment mechanism and a lip;
applying a force such that said flap of said male member attachment mechanism enters said female member attachment mechanism until said step abuts said lip;
wherein once said step abuts said lip, if a force is applied to remove said male member attachment mechanism from said female member attachment mechanism, said lip exerts a force on said step resisting said force applied to remove said male member attachment mechanism.
